(19) United States
(12) Patent Application Publication
(10) Pub. No.: US 2021/0117856 A1
(43) Pub. Date: Apr. 22, 2021

(54) System and Method for Configuration and Resource Aware Machine Learning Model Switching

(71) Applicant: Dell Products L.P., Round Rock, TX (US)

(72) Inventors: Nikhil M. Vichare, Austin, TX (US); Vivek Viswanathan Iyer, Austin, TX (US)

(73) Assignee: Dell Products L.P., Round Rock, TX (US)

(21) Appl. No.: 16/659,981

(22) Filed: Oct. 22, 2019

(51) Int. Cl. G06N 20/00; G06N 3/08; G06N 3/04; G06F 9/50

(52) U.S. Cl. CPC G06N 20/00; G06F 9/5011; G06N 3/04; G06N 3/08

(57) ABSTRACT

A system, method, and computer-readable medium are disclosed for configuring machine learning models to optimize resources of information handling system. Multiple machine learning models with different complexities are trained as to accuracy over different platforms. The machine learning models are mapped based on accuracy and computational complexity. A determination is made as to is machine learning models are applicable for particular information handling system platforms. The machine learning models are provided to the information handling system platforms for installation.

### BACKGROUND OF THE INVENTION

### Field of the Invention

The present invention relates to the management of information handling systems. More specifically, embodiments of the invention provide a system, method, and computer-readable medium for configuring machine learning models to optimize resources of information handling systems.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Platforms of information handling systems can vary from relatively simple handheld devices, such as cellular phones, to complex computing devices, such as server computers. The resources of different platforms also vary in computational complexity. Resources of information handling devices can include computing (e.g., central processing unit), memory (e.g., random access memory, read only memory, storage, etc.), input/output (I/O), power (e.g., battery, charging), etc. In order to make such information handling systems more efficient, solutions, such as machine learning (ML) models that can include artificial neural networks (ANN) can be implemented on information handling systems. Such ML models use the resources of the information handling systems and can consume a considerable amount of the resources. Relatively complex information handling systems having platforms with relatively higher resource capacity are able to absorb the resource demands of most ML models. Relatively simple information handling systems having platforms with relatively lower resource capacity may not afford the resource demands of certain ML models. In certain implementations, a manufacturer or supplier of an information handling system may provide a cap of the amount of the resources an ML model can consume, such as 3% of all system resources. If a single ML model is implemented across different platforms, the cap may be met by the more complex information handling systems but may be exceeded by the simpler information handling systems.

### SUMMARY OF THE INVENTION

A system, method, and computer-readable medium are disclosed for configuring machine learning models to optimize resources of information handling system. Multiple machine learning models with different complexities are trained as to accuracy over different platforms. The machine learning models are mapped based on accuracy and computational complexity. A determination is made as to which machine learning models are applicable for particular information handling system platforms. The machine learning models are provided to the information handling system platforms for installation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system for machine learning model training;

FIG. 2 is a general illustration of components of an information handling system implementing a machine learning model for resource optimizing;

FIG. 3 is a simplified block diagram of a system for configuring machine learning models to optimize resources of information handling systems;

FIG. 4 is a general flowchart for training of machine learning models for optimization of resources of information handling systems; and

FIG. 5 is a comparison of classification accuracy of different optimizers/machine learning models; and

FIG. 6 is a general flowchart for implementing of machine learning models for optimization of resources of information handling systems.

### DETAILED DESCRIPTION

A system, method, and computer-readable medium are disclosed for configuring machine learning models to optimize resources of information handling system. On an information handling system, an appropriate optimizer or machine learning (ML) model can be implemented, which is based on the particular information handling system's configuration, and a cap based on the amount of resources on the information handling system can be used by the optimizer/ML model. The optimizer/ML model is aware of the resources of the information handling system and can adjust or switch the resources to optimize such resources. The optimizer/ML model can have a fidelity scale as to service identifier, shop keeping unit (SKU), etc. as to platform performance and other optimizations for the optimizer/ML model. Therefore, a balance can be achieved as to optimizer/ML model execution and performance (feature delivery) on the information handling system with resource availability/capability.

Describe herein are systems and process that can be implemented to determine what requirements are needed, constraints of a particular platform. Based on the constraints and requirements, implementation and decision can be made as to the type of the optimizer/ML model to use on a particular information handling system. There can be different optimizers/ML models that support different platform resource functions, such as computing, workload storage, power/battery consumption/usage, etc. Training of different optimizers/ML models, and their neural networks can be performed for different platform resource functions or applications. In the training, different parameters can be looked which affect performance of optimizers/ML models. Such parameters can be adjusted to change to improve efficiency.

In certain implementations, based on target configuration variability, multiple optimizers/ML models can be trained using the same data. The optimizers/ML models can vary by computational complexity and accuracy. A minimum threshold accuracy can be set across all optimizers/ML models. A maximum threshold can be set as to resource consumptions across all models. The optimizers/ML models can be trained with various complexities, which fit between the accuracy and resource limits. This can be achieved by tuning the parameters of an optimizer/ML model, such in the case of neural network, the number of neurons, number of layers, neurons per layer, activation functions, drop-out layers, etc.

A mapping can be developed of optimizers/ML models as to system configurations suited for execution. For example, relatively simple information handling systems having platforms with relatively lower resource capacity can be implemented with an optimizer/ML model with lower accuracy and low resource consumption, and relatively complex information handling systems having platforms with relatively higher resource capacity can be implemented with an optimizer/ML model with higher accuracy and higher resource consumption. Therefore, an information handling system can be integrated with the appropriate optimizer/ML model.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware Of software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

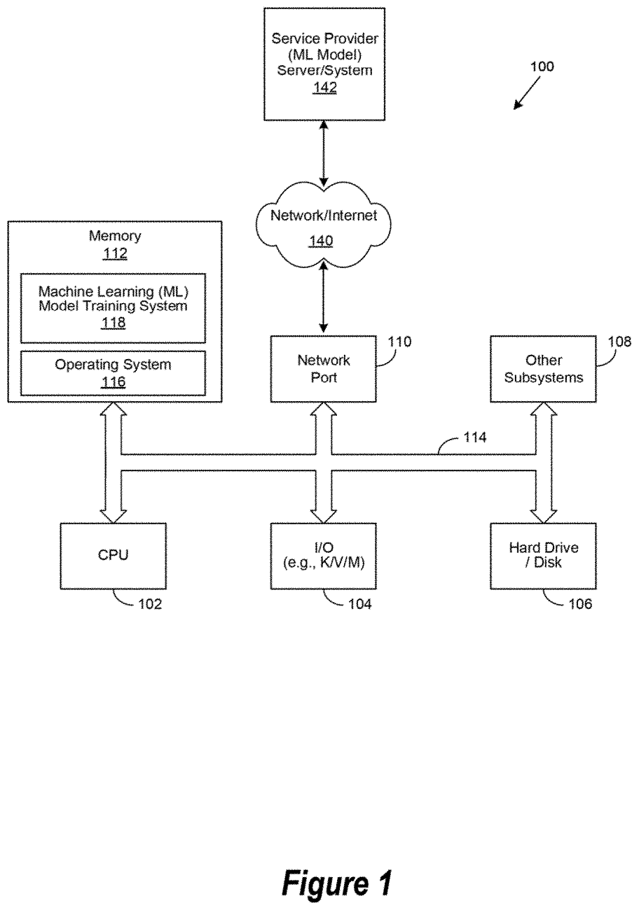

FIG. 1 is a generalized illustration of an information handling system 100 that can be used to implement the system and method of the present invention. In particular, for certain implementations, the information handling system 100 provides for machine learning model training. The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108. In various embodiments, the information handling system 100 also includes network port 110 operable to connect to a network 140, which is likewise accessible by a service provider server 142. In certain implementations, the service provider server 142 provides machine language models to other information handling devices, such as user devices, as further discussed below. In certain embodiments, the service provider server 142 is implemented as a part of a cloud service.

The information handling system 100 likewise includes system memory 112, which is interconnected to the foregoing via one or more buses 114. System memory 112 further includes an operating system (OS) 116 and in various embodiments may also include a Machine Learning (ML) model training system 118. In general, ML model training system 118 receives and configures machine learning models for use by different information handling system (e.g., user device) platforms. Such ML models can include artificial neural networks (ANN) and other components to optimize use of resources of various information handling systems (e.g., user devices). Such ML models and ANN can be implemented to perform tasks by considering examples, generally without being programmed with task-specific rules. An ANN particularly receives inputs, processes the inputs through various neuron layers and neurons, and provides outputs. The inputs can be from the various resources of an information handling system, and the outputs can be recommendations/settings used in optimizing the resources of the information handling systems.

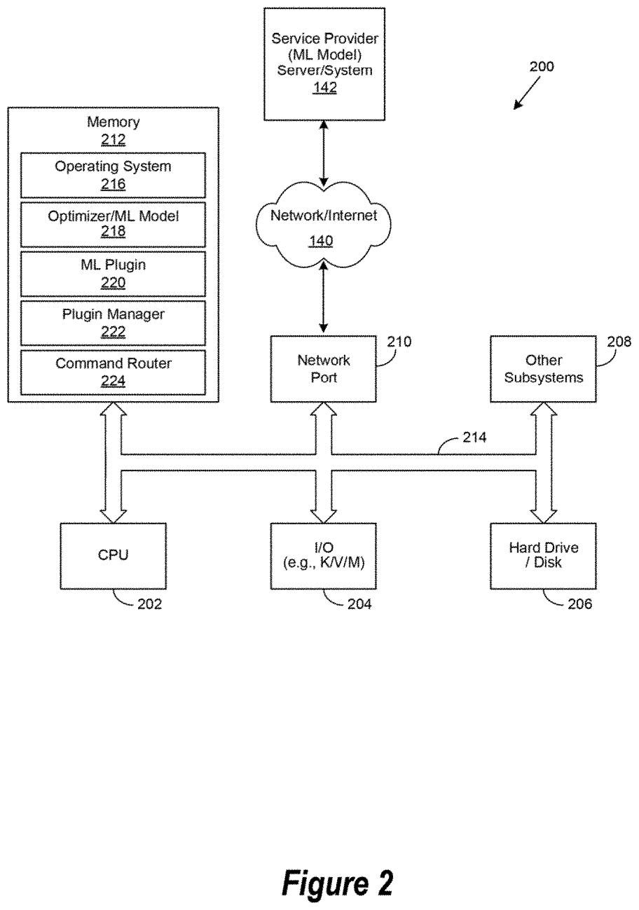

FIG. 2 is a generalized illustration of an information handling system 100 that can be used to implement the system and method of the present invention. In particular, the information handling system 200 implements a machine learning model for resource optimizing. The information handling system 200 includes a processor (e.g., central processor unit or “CPU”) 202, input/output (I/O) devices 204, such as a microphone, a keyboard, a video/display, a mouse, and associated controllers (e.g., K/V/M), a hard drive or disk storage 206, and various other subsystems 208. In various embodiments, the information handling system 200 also includes network port 210 operable to connect to the network 140, which is likewise accessible by the service provider server 142. In certain implementations, the service provider server 142 provides machine language models to the information handling system 200.

The information handling system 200 likewise includes system memory 212, which is interconnected to the foregoing via one or more buses 214. System memory 212 further includes an operating system (OS) 216 and in various embodiments may also include an optimizer or machine learning model 218. The optimizer/ML model 218 can be directed to how an individual uses the information handling system 200 as to different parameters, such as computing processing, charging, discharging, battery, adapter, processing, memory, connections (I/O), etc. The optimizer/ML model 218 can be implemented to optimize the resources of the information handling system 200. Examples of resources include computing (e.g., central processing unit), memory (e.g., random access memory, read only memory, storage, etc.), input/output (I/O), power (e.g., battery, charging), etc. In certain implementations, the system memory 212 can also include an ML plugin runtime component 220, a plugin manager 222 and command router 224, which can be used in downloading/installing/managing configurations of the optimizer/ML model 218. In certain implementations, resources of information handling system 200 are made aware and machine learning models may be switched.

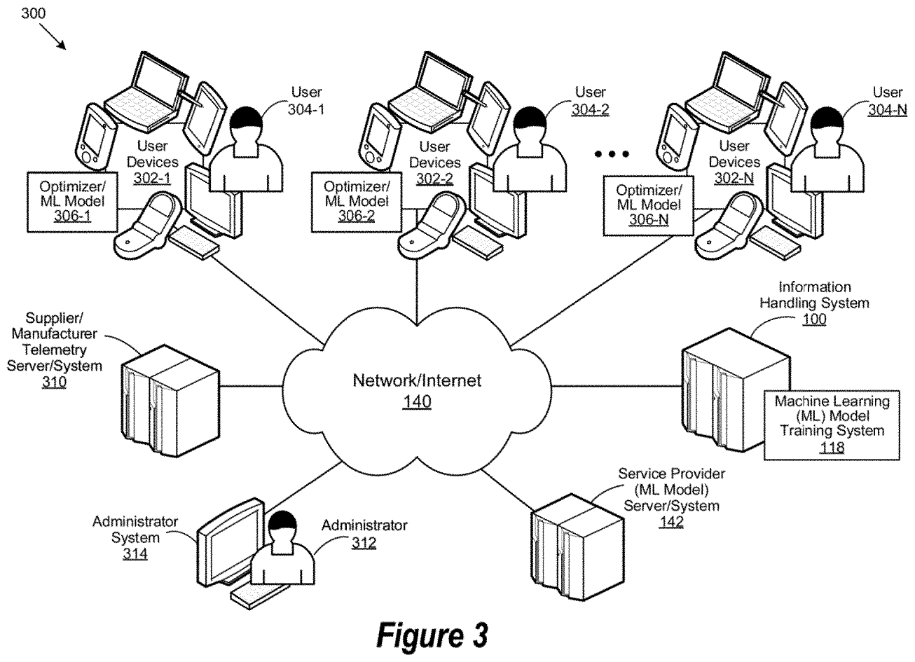

FIG. 3 is a simplified block diagram of a system 300 for configuring machine learning models to optimize resources of information handling systems. The system 300 supports various user devices 302-1, 302-2 to 302-N, that are respectively used by users 304-1, 302-2 to 302-N. As used herein, the user devices 302 refer to an information handling system such as a personal computer, a laptop computer, a tablet computer, a personal digital assistant (PDA), a smart phone, a mobile telephone, or other device that is capable of communicating and processing data. In certain implementations, the user devices 302-1, 302-2 to 302-N respectively include optimizer/ML model 306-1, optimizer/ML model 306-2 to optimizer/ML model 306-N. An appropriate optimizer/ML model 306 can be provided on user device 302 based on system configuration/platform of the user device 302. A factor that can determine the optimizer/ML model 306 can be a target cap, such as set by a supplier or manufacturer of the user device 302. In certain implementations, a fidelity score tied to platform and optimizer/ML model 306 performance can be used to determine the optimizer/ML model 306. The fidelity score can be based on service identification, product/device stock keeping unit (SKU), etc. The use of an appropriate optimizer/ML model 306 for a particular user device platform can balance optimizer/ML model 306 execution and predictive feature delivery with system user device 302 resource availability/capability.

The system 300 further includes the information handling system 100, and the Machine Learning (ML) model training system 118. As discussed above, in general, ML model training system 118 receives and configures optimizer/ML model 306 for use by user device 302 platforms. The configured optimizer/ML model 306 of ML model training system 118 may be stored at and provided by the service provider server 142. As discussed above, the service provider server 142 can provide the appropriate optimizers/ML models 306 to the user devices 302. In certain embodiments, the service provider server 142 is implemented as a part of a cloud service. In certain implementations, the service provider server 142 connects to the ML plugin runtime component 220 described in FIG. 2.

In certain embodiments, the system 300 includes a supplier/manufacturer telemetry server/system 308, which can connect to the user devices 302. The supplier/manufacturer telemetry server/system 308 can provide other data/information to the user devices 302, which can be related to resources of the devices 302. In certain implementations, the supplier/manufacturer telemetry server/system 308 can provide bundled appropriate optimizers/ML models 306 as part of an application for user devices 302, where upon installation a determination can be made as to what platform/system configuration exist on the user, device, selecting and installing the appropriate optimizer/ML model 306. In certain embodiments, the supplier/manufacturer telemetry server/system 308 is implemented as a part of a cloud service.

In certain implementations, the system 300 can include various administrators as represented by administrator 310. Administrator 310 can be business units, such as product support units, marketing, product development, security administrators, etc. In general, administrator 310 can include units directly or indirectly involved in supporting user devices 302 and users 304. Administrator 310 interacts with other users/systems of system 300 using administrator system 312. In certain implementations, the administrator system 312 can be representative of a business/computing environment that includes various computing devices (e.g., servers), storage, software solutions, hardware (e.g., accessories), etc. In certain implementations, the administrator system 312 is part of a cloud service.

The various devices, systems, cloud services of system 300 can be connected to one another through the network 140. In certain embodiments, the network 140 may be a public network, such as the Internet, a physical private network, a wireless network, a virtual private network (VPN), or any combination thereof. Skilled practitioners of the art will recognize that many such embodiments are possible, and the foregoing is not intended to limit the spirit, scope or intent of the invention.

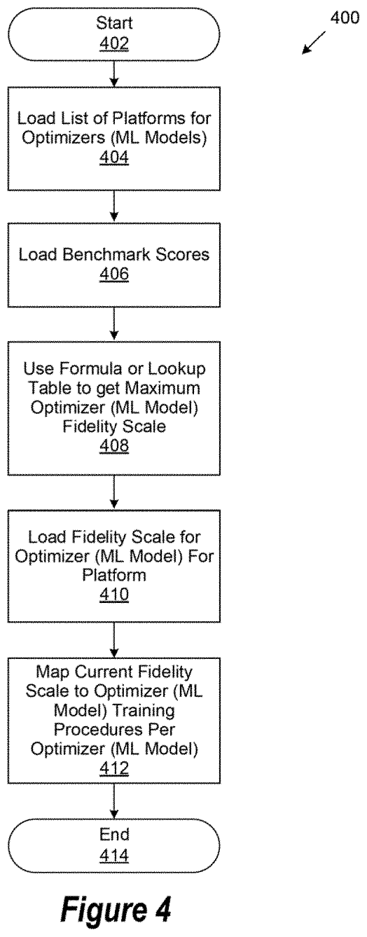

FIG. 4 is a generalized flowchart 400 for training of machine learning models for optimization of resources of information handling systems. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 402 the process 400 starts. At step 404, a list is loaded of different configuration platforms that can implement optimizers or machine learning (ML) models. The list may include configuration policies of platforms (e.g., SKUs or service identifiers) for a broad optimizer/ML model coverage across optimizer/ML components.

At step 406, benchmark scores are loaded. The benchmark scores can be for a list of the different platforms, and cover resources such as CPU score, I/O score, power score, memory score, etc.

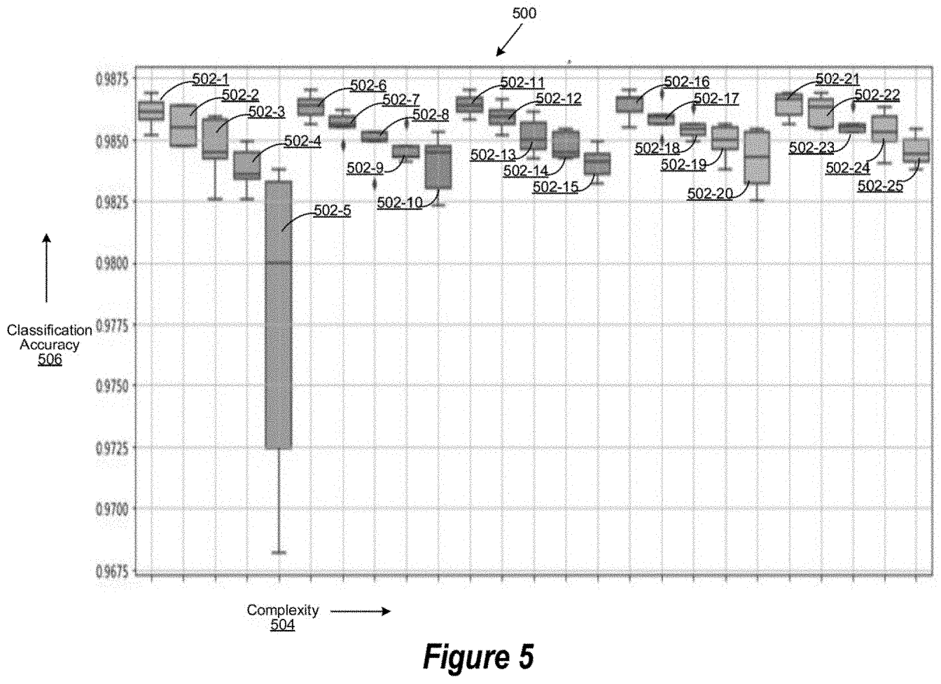

At step 408, a fidelity scale (e.g. scale from 1 to 10) is determined using a formula or lookup table. The fidelity scale can be related to classification accuracy as further described below in the comparison of FIG. 5. The fidelity scale is related to a for optimizer/ML model computing/usage of resources based on the benchmark scores at step 406.

At step 410, the fidelity scale for the optimizer/ML model for a platform is loaded. The fidelity scale can be a function of optimizer/ML model and platform (e.g., SKU of platform).

At block 412, a current fidelity scale is mapped training procedures per optimizer/ML model. A minimum threshold may be set on the accuracy (or other predictive metric across optimizer/ML models. A maximum threshold may be set on the compute resource consumptions across optimizers/ML models. Optimizers/ML models may be trained with various complexities that fit between the accuracy and resource limits. In certain implementations, the parameters of the optimizers/ML models can be tuned as to the activation functions, and for neural networks, the number of neurons, number of layers, dropout layers, etc. An index can be performed by assigning identifiers to optimizers/ML models. Telemetry from multiple users can be received from a data lake or other store. An output is of optimizers/ML models classified per fidelity scale. At block 414, the process 400 ends.

FIG. 5 is a comparison of classification accuracy of different optimizers/machine learning models. The comparison can be based on storage workload classification. In this example, the comparison graph 500 plots 25 optimizers/machine learning models 502. The optimizers/machine learning models 502 can be a list provided from the process 400 of FIG. 4. For example, the output can be of optimizers/ML models classified per fidelity scale. Along the X axis of comparison graph 500 is computational complexity 504 of the optimizers/machine learning models 502. For example, computational complexity for a neural network-based optimizers/machine learning models 502 can be measured by number of layers of the neural network, number of neurons in particular layers, layer dropout rate, etc. Along the Y axis comparison graph 500 is classification accuracy 506 of the optimizers/machine learning models 502. The higher number, the better classification accuracy. A determination can be made as to which optimizers/machine learning models 502 is appropriate for a particular platform. Platforms of relatively simpler devices that cannot sacrifice too many resources are best served by the less complex optimizers/machine learning models 502.

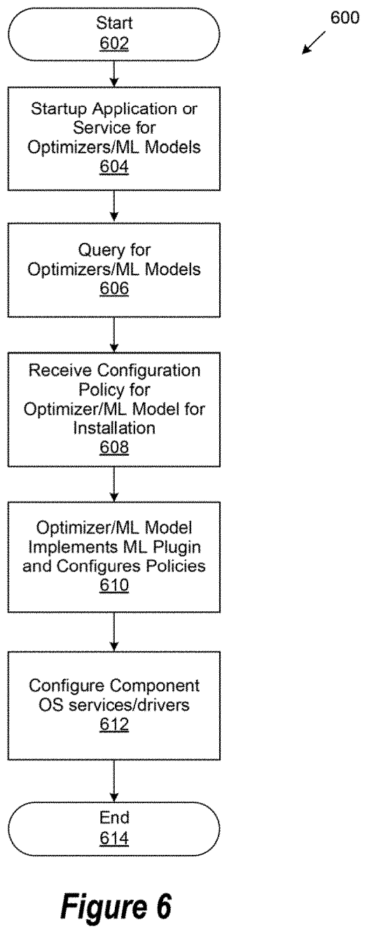

FIG. 6 is a general flowchart for implementing of machine learning models for optimization of resources of information handling systems. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof without departing from the scope of the invention.

At block 602 the process 600 starts. At step 604, an application at an information handling system is started tip or a service is called up by the information handling system for optimizers/ML models and particularly for service identification checks to receive service identifier (ID), SKU, and license entitlements of the information handling system.

At step 606, a direct or indirect query is performed to a service, such as the service provider server 142 described above as to optimizers/ML models. The optimizers/ML models may be related as to particular fidelity scales as described above.

At step 608, configuration policy is received for the optimizer/ML model as to installation on the information handling system. In certain implementations, a service, such as the service provider server 142 provides the configuration policy to save locally to ML plugin runtime component 220 described in FIG. 2.

At step 610, the optimizer/ML model configures policies. In certain implementations, the configuring is performed through ML plugin runtime component 220 through command router 224 describe in FIG. 2. In particular, plugin components of the information handling system are configured as to the policies.

At step 612, the operating system (OS) services and drivers (i.e., components) area configured. In certain implementations, plugin components of the information handling system plugins use a manageability interface to perform the configuring. At block 614, the process 600 ends.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area. network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Skilled practitioners of the art will recognize that many such embodiments are possible, and the foregoing is not intended to limit the spirit, scope or intent of the invention. Consequently, the invention is intended to be limited only by the spirit and scope of the appended claims, giving full cognizance to equivalents in all respects.

What is claimed is:

1. A computer-implementable method for configuring machine learning models to optimize resources of information handling systems:
training multiple machine learning models having different complexities as to accuracy over different platforms;
mapping the machine learning models based on accuracy and computational complexity;
determining applicable machine learning models for particular platforms; and
providing the applicable machine learning models to information handling systems of the particular platforms.

2. The method of claim 1, wherein the machine learning models are directed to a particular function or application that is performed on the platforms.

3. The method of claim 1, wherein the training comprises adjusting different parameters of machine learning models to increase accuracy over the different platforms.

4. The method of claim 1, wherein the training comprises providing a fidelity scale for the machine learning models.

5. The method of claim 1, wherein the determining comprises providing a cap as to resources consumed by a machine learning model on a platform.

6. The method of claim 1, wherein the machine learning models comprise artificial neural networks.

7. The method of claim 1, wherein the providing comprises sending machine learning models to a service which provides the machine learning models to the information handling systems of the particular platforms.

8. A system comprising:
a processor;
a data bus coupled to the processor; and
a non-transitory, computer-readable storage medium embodying computer program code, the non-transitory, computer-readable storage medium being coupled to to the data bus, the computer program code interacting with a plurality of computer operations for configuring machine learning models to optimize resources of information handling systems executable by the processor and configured for:
training multiple machine learning models having different complexities as to accuracy over different platforms;
mapping the machine learning models based on accuracy and computational complexity;
determining applicable machine lean tip models for particular platforms; and
is providing the applicable machine learning models to information handling systems of the particular platforms.

9. The system of claim 8, wherein the machine learning models are directed to a particular function or application that is performed on the platforms.

10. The system of claim 8, wherein the training comprises adjusting different parameters of machine learning models to increase accuracy over the different platforms.

11. The system of claim 8, wherein the training comprises providing a fidelity scale for the machine learning models.

12. The system of claim 8, wherein the determining comprises providing a cap as to resources consumed by a machine learning model on a platform.

13. The system of claim 8, wherein the machine learning models comprise artificial neural networks.

14. The system of claim 8, wherein the providing comprises sending machine learning models to a service which provides the machine learning models to the information handling systems of the particular platforms.

15. A non-transitory, computer-readable storage medium embodying computer program code, the computer program code comprising computer executable instructions configured for:
training multiple machine learning models having different complexities as to accuracy over different platforms;
mapping the machine learning models based on accuracy and computational complexity;
determining applicable machine learning models for particular platforms; and
providing the applicable machine learning models to information handling systems of the particular platforms.

16. The non-transitory, computer-readable storage medium of claim 15, wherein the training comprises adjusting different parameters of machine learning models to increase accuracy over the different platforms.

17. The non-transitory, computer-readable storage medium of claim 15, wherein the training comprises providing a fidelity scale for the machine learning models.

18. The non-transitory, computer-readable storage medium of claim 15, wherein the training comprises providing a fidelity scale for the machine learning models.

19. The non-transitory, computer-readable storage medium of claim 15, wherein the determining comprises providing a cap as to resources consumed by a machine learning model on a platform.

20. The non-transitory, computer-readable storage medium of claim 15, wherein the machine learning models comprise artificial neural networks.
